(19) United States
(12) Patent Application Publication
(10) Pub. No.: US 2016/0280885 A1
(43) Pub. Date: Sep. 29, 2016

(54) RESIN COMPOSITION AND RESIN MOLDED ARTICLE

(71) Applicant: FUJI XEROX CO., LTD., Tokyo (JP)

(72) Inventors: Hisae YOSHIZAWA, Kanagawa (JP); Kenji YAO, Kanagawa (JP); Masahiro MORIYAMA, Kanagawa (JP)

(21) Appl. No.: 14/822,087

(22) Filed: Aug. 10, 2015

(30) Foreign Application Priority Data
Mar. 26, 2015 (JP) 2015-064766

(51) Int. Cl. C08K 5/11

(52) U.S. Cl. CPC C08K 5/11

(57) ABSTRACT

A resin composition includes 80% by weight or more of a cellulose derivative with respect to a total amount of a resin composition and has a melt viscosity in a range of from 100 Pa·s to 200 Pa·s at a temperature of 220° C. and a shear velocity of 1,000/s.

### CROSS-REFERENCE TO RELATED APPLICATIONS

This application is based on and claims priority under 35 USC 119 from Japanese Patent Application No. 2015-064766 filed Mar. 26, 2015.

### BACKGROUND

1. Technical Field

The invention relates to a resin composition and a resin molded article.

2. Related Art

In the past, various resin compositions are provided to be used for various applications. For example, thermoplastic resins are used in various components and housings of home appliances or automobiles, or in components such as housings of business machines and electric and electronic apparatuses.

Recently, resins derived from plants are used, and a cellulose derivative is one of the resins derived from plants which are well-known from the past.

### SUMMARY

According to an aspect of the invention, there is provided a resin composition including 80% by weight or more of a cellulose derivative with respect to a total amount of a resin composition and having a melt viscosity in a range of 100 Pa·s to 200 Pa·s at a temperature of 220° C. and a shear velocity of 1,000/s.

### DETAILED DESCRIPTION

Hereinafter, exemplary embodiments which are examples of a resin composition and a resin molded article according to the invention are described below.

Resin Composition

The resin composition according to the exemplary embodiment is a resin composition (hereinafter, also referred to as a “specific resin composition”) that contains 80% by weight or greater of a cellulose derivative with respect to a total amount of a resin composition, of which melt viscosity is in a range of 100 Pa·s to 200 Pa·s in a condition in which a temperature is 220° C. and a shear velocity is 1,000/s.

In general, since characteristics of the chemical structure of the cellulose derivative and characteristics in which intramolecular and intermolecular hydrogen bonding strength is strong, the cellulose derivative may provide a resin molded article having an excellent elastic modulus, but has inferior moldability when being heat-melted and molded.

Here, as a method of increasing moldability of the cellulose derivative, a method of adding a plasticizer may be considered. However, as the added amount of the plasticizer is increased, the generation of bleedout (effusion to the surface) of the plasticizer after molding is increased, and also the cost is increased. Therefore, the resin composition containing the cellulose derivative as a main component (specifically, the content of the cellulose derivative is 80% by weight or more) and having excellent moldability is desired.

In addition, when the resin molded article is formed by using a cellulose derivative, for example, if a high temperature of 250° C. or greater is applied, the cellulose derivative may be thermally decomposed, and bad odor may be generated due to the thermal decomposition. Therefore, a resin composition capable of preventing thermal decomposition of a cellulose derivative and having excellent moldability is desired.

On the other hand, the resin composition according to the exemplary embodiment contains 80% by weight or greater of a cellulose derivative, and has a melt viscosity in a range of 100 Pa·s to 200 Pa·s in a condition in which a temperature is 220° C. and a shear velocity is 1,000/s, and thus a resin composition in which thermal decomposition of a cellulose derivative is prevented and moldability is excellent may be obtained.

The effect is considered to be achieved as follows. Since the melt viscosity of the resin composition containing 80% by weight or greater of a cellulose derivative as a main component is in the range described above, the resin composition may have excellent thermal fluidity (melt viscosity-lowering properties when heat is applied) and thus the excellent moldability is obtained. Also, according to the excellent moldability, a resin molded article having excellent molding precision may be obtained.

In addition, in the case where the melt viscosity of the resin composition containing 80% by weight or more of the cellulose derivative at 220° C. is in the range described above, the heating temperature in molding the resin composition may be reduced. Therefore, it is considered that the thermal decomposition of the cellulose derivative when the resin composition is molded may be prevented, and as a result, the generation of the bad odor due to the thermal decomposition may be prevented.

Melt Viscosity of Resin Composition

The melt viscosity of the resin composition according to the exemplary embodiment indicates melt viscosity of the resin composition containing 80% by weight or more of a cellulose derivative. Accordingly, in the case where the resin composition contains other components than the cellulose derivative such as a plasticizer, the melt viscosity is a value obtained by measuring the resin composition containing the cellulose derivative and the other components.

The melt viscosity of the resin composition having a temperature of 220° C. at a shear velocity of 1,000/s is preferably in the range of 100 Pa·s to 200 Pa·s, and more preferably in the range of 120 Pa·s to 180 Pa·s.

If the melt viscosity of the resin composition is greater than the upper limit, excellent moldability of the resin composition is not obtained, and it is difficult to decrease the heating temperature when the resin composition is molded. Therefore, the effect of preventing thermal decomposition of the cellulose derivative is not be satisfactorily obtained. Meanwhile, if the melt viscosity of the resin composition is lower than the lower limit, it is difficult to obtain a resin molded article having an excellent elastic modulus.

The melt viscosity of the resin composition is measured by the following methods. The viscosity (Pa·s) is measured under the condition in which the temperature is 220° C. and the shear velocity is 1,000/s, in conformity with JIS K7199 (1999) by using Capilograph-1C (Toyo Seiki Seisaku-sho, Ltd.).

Method of Achieving Melt Viscosity of Resin Composition

A method of controlling the melt viscosity of the resin composition containing 80% by weight or more of the cellulose derivative to the range described above is not particularly limited, but, for example, a method of adjusting the weight average molecular weight of the cellulose derivative, a method of selecting a kind of a substituent to be included in the cellulose derivative, and a method of adjusting a substitution degree in the cellulose derivative are included. These methods of controlling the melt viscosity of the resin composition are described in detail below.

Subsequently, components of the resin composition according to the exemplary embodiment are described in detail.

Cellulose Derivative

The “cellulose derivative” to be used in the exemplary embodiment refers to a compound in which at least one hydroxyl group included in cellulose is substituted with a substituent.

The cellulose derivative used in the exemplary embodiment is not particularly limited, but in view of controlling the melt viscosity of the resin composition to the scope described above, it is preferable that a weight average molecular weight, a molecular structure, and the like are preferably in the ranges described below.

Weight Average Molecular Weight

In view of controlling the melt viscosity of the resin composition to be in the range described above, the cellulose derivative used in the exemplary embodiment is preferably a cellulose derivative (hereinafter, also referred to as “specific cellulose derivative”) of which a weight average molecular weight is 10,000 or greater and less than 75,000. The weight average molecular weight is more preferably in the range of 20,000 to 50,000.

In addition, if the weight average molecular weight is less than 75,000, owing to the hydrogen bond between molecules of the cellulose derivative, an excellent elastic modulus may be obtained and heat resistance is also enhanced. Meanwhile, if the weight average molecular weight is 10,000 or greater, since the molecular weight is not too low, an excellent elastic modulus may be obtained, and the heat resistance is also enhanced.

Here, the weight average molecular weight (Mw) is a value measured by gel permeation chromatography (GPC). Specifically, the molecular weight measurement by GPC is performed with a GPC apparatus (manufactured by Tosoh corporation, HLC-8320GPC, Column: TSKgel α-M) by using a solution of dimethylacetamide/lithium chloride having a volume ratio of 90/10.

Structure

The cellulose derivative is preferably a compound in which at least one hydroxyl group included in cellulose is substituted with an acyl group, and specifically a compound represented by the formula (1) below.

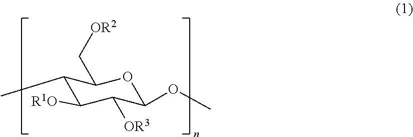

In the formula (1), R¹, R², and R³ each independently represent hydrogen atoms or acyl groups. n represents an integer of 2 or greater. However, at least one of plural R's, plural R²s and plural R³s represents an acyl group.

Among compounds represented by the formula (1), if plural acyl groups exist, the respective acyl groups may be identical to each other, may be partially identical to each other, or may be different from each other.

In the formula (1), a range of n is not particularly limited, but may be determined according to the preferable scope of the weight average molecular weight described above. Specifically, n is preferably in the range of 40 to 300, and more preferably in the range of 100 to 200.

If n is 40 or greater, the strength of the resin molded article is easily increased. If n is 300 or lower, the decrease of flexibility of the resin molded article is easily prevented.

Acyl Group

For easily obtaining a resin molded article having a high elastic modulus and an excellent heat resistance, the acyl groups represented by R¹, R², and R³ are preferably acyl groups having 1 to 6 carbon atoms, and more preferably acyl groups having 2 to 4 carbon atoms. In addition, in view of controlling the melt viscosity of the resin composition to the scope described above, the number of carbon atoms of the acyl group is preferably greater in the range described above.

Plural R¹s, plural R²s, and plural R³s may be identical to each other, may be partially identical to each other or may be different from each other.

The acyl group having 1 to 6 carbon atoms is represented by a structure of “—CO—R_{AC}”, and “R_{AC}” represents a hydrogen atom or a hydrocarbon group having 1 to 5 carbon atoms.

The hydrocarbon group represented by “R_{AC}” may have any one of a linear shape, a branched shape, or a cyclic shape, but preferably a linear shape.

In addition, the hydrocarbon group may be a saturated hydrocarbon group or an unsaturated hydrocarbon group, but preferably a saturated hydrocarbon group.

In addition, the hydrocarbon group may contain other atoms than carbon or hydrogen (for example, oxygen or nitrogen), but preferably a hydrocarbon group made of only carbon and hydrogen.

As the acyl group having 1 to 6 carbon atoms, a formyl group, an acetyl group, a propionyl group, a butyryl group (butanoyl group), a propenoyl group, a hexanoyl group, and the like are exemplified.

Among these acyl groups, an acetyl group is preferable in view of the enhancement of the elastic modulus and the heat resistance and the enhancement of the moldability of the resin composition.

Substitution Degree

The substitution degree of the cellulose derivative is preferably in the range of 1.8 to 2.5 in view of the control of the melt viscosity of the resin composition to the range described above. Further, the substitution degree is more preferably in the range of 2 to 2.4.

In the case where the substitution degree is 2.5 or less, since the interaction between substituents does not become too high, and the decrease of mobility of atoms is prevented, the hydrogen bond between molecules easily occurs, and the elastic modulus becomes higher, and the effect of increasing the heat resistance may be obtained as well. Meanwhile, In the case where the substitution degree is greater than 1.8, the interaction between molecules does not become too small and plasticization is prevented, such that the elastic modulus becomes higher and the effect of increasing the heat resistance may be obtained as well.

In addition, the substitution degree is an index indicating a degree at which a hydroxyl group included in the cellulose is substituted by a substituent. As described above, if the substituent is an acyl group, the substitution degree becomes an index indicating the degree of acylation of the cellulose derivative. Specifically, the substitution degree means an intramolecular average of the number of substitutions in which three hydroxyl groups included in a D-glucopyranose unit of the cellulose derivative are substituted with an acyl group.

Synthesis Method

A method of preparing the cellulose derivative used in the exemplary embodiment is not particularly limited, and well-known methods are employed.

Hereinafter, a method of preparing a cellulose derivative in which the weight average molecular weight is 10,000 or greater and less than 75,000 and at least one hydroxyl group of the cellulose is substituted with an acyl group having 1 to 6 carbon atoms is described.

Adjustment of Molecular Weight of Cellulose

First, cellulose before acylation, that is, cellulose of which a hydroxyl group is not substituted with an acyl group, is prepared and the molecular weight thereof is adjusted.

As the cellulose before acylation, cellulose prepared arbitrarily may be used or commercially available cellulose may be used. Incidentally, the cellulose is usually a resin derived from plants, and the weight average molecular weight thereof is generally higher than that of the specific cellulose derivative according to the exemplary embodiment. Therefore, the adjustment of the molecular weight of the cellulose generally includes a step for decreasing the molecular weight.

For example, the weight average molecular weight of the commercially available cellulose is generally in the range of 150,000 to 500,000.

As the commercially available cellulose before acylation, for example, KC Flock (W50, W100, W200, W300G, W400G, W-100F, W60MG, W-50GK, and W-100GK), NDPT, NDPS, LNDP, and NSPP-HR manufactured by Nippon Paper Industries Co., Ltd. are included.

A method of adjusting a molecular weight of the cellulose before acylation is not particularly limited, but for example, there is a method of decreasing the molecular weight by stirring the cellulose in liquid.

By adjusting the speed and the time for the stirring of the cellulose is stirred, the molecular weight of the cellulose may be adjusted to a required value. In addition, though not particularly limited, the stirring speed when the cellulose is stirred is preferably in the range of 50 rpm to 3,000 rpm, and more preferably in the range of 100 rpm to 1,000 rpm. In addition, the stirring time is preferably in the range of 2 hours to 48 hours, and more preferably in the range of 5 hours to 24 hours.

In addition, as the liquid used when the cellulose is stirred, an aqueous solution of hydrochloric acid, an aqueous solution of formic acid, an aqueous solution of acetic acid, an aqueous solution of nitric acid, and an aqueous solution of sulfuric acid are exemplified.

Preparation of Cellulose Derivative

The cellulose of which the molecular weight is adjusted by the methods described above is acylated with an acyl group having 1 to 6 carbon atoms by a well-known method, to thereby obtain a cellulose derivative.

For example, for the case where at least one hydroxyl group included in the cellulose is substituted with an acetyl group, a method of esterifying the cellulose by using the mixture of acetic acid, acetic anhydride, and sulfuric acid is exemplified. In addition, for the case where at least one hydroxyl group included in the cellulose is substituted with a propionyl group, a method of performing esterification by using propionic anhydride in substitution for the acetic anhydride of the mixture is exemplified, for the case where at least one hydroxyl group included in the cellulose is substituted with a butanoyl group, a method of performing esterification by using butyric anhydride in substitution for the acetic anhydride of the mixture is exemplified, and for the case where at least one the hydroxyl group included in the cellulose is substituted with a hexanoyl group, a method of performing esterification by using hexanoic anhydride in substitution for the acetic anhydride of the mixture is exemplified.

After acylation, in order to adjust the substitution degree, a deacylation step may be further performed. In addition, after the acylation step or the deacylation step, a step of further refining the cellulose may be preformed.

Ratio of Cellulose Derivative Occupied in Resin Composition

The ratio occupied by the cellulose derivative with respect to the total amount of the resin composition according to the exemplary embodiment is 80% by weight or more, more preferably 90% by weight or more, and may be 99% by weight or more. If the ratio is 80% by weight or greater, an elastic modulus is increased, and also heat resistance becomes higher.

Plasticizer

The resin composition according to the exemplary embodiment may further contain a plasticizer.

In addition, the content of the plasticizer is such an amount that the ratio of the cellulose derivative occupied in the total amount of the resin composition becomes the range described above. More specifically, the ratio of the plasticizer with respect to the total amount of the resin composition is preferably 15% by weight or lower, more preferably 10% by weight or lower, and still more preferably 5% by weight or lower. If the ratio of the plasticizer is in the range described above, an elastic modulus becomes higher, and thus heat resistance becomes higher as well. In addition, bleeding of the plasticizer is prevented.

For example, as the plasticizer, an adipic acid ester-containing compound, a polyether ester compound, a sebacic acid ester compound, a glycol ester compound, an acetic acid ester, a dibasic acid ester compound, a phosphoric acid ester compound, a phthalic acid ester compound, camphor, citric acid ester, stearic acid ester, metallic soap, polyol, polyalkylene oxide, and the like are exemplified.

Among these, an adipic acid ester-containing compound, and a polyether ester compound are preferable, and an adipic acid ester-containing compound is more preferable.

Adipic Acid Ester-Containing Compound

An adipic acid ester-containing compound (compound containing adipic acid ester) refers to a compound of individual adipic acid esters, and a mixture of adipic acid ester and components other than adipic acid ester (compound different from adipic acid ester). However, the adipic acid ester-containing compound may preferably contain the adipic acid ester by 50% by weight or more with respect to the total of adipic acid ester and other components.

As the adipic acid ester, for example, adipic acid diester, and adipic acid polyester are exemplified. Specifically, adipic acid diester represented by the formula (2-1) and adipic acid polyester represented by the formula (2-2) are exemplified.

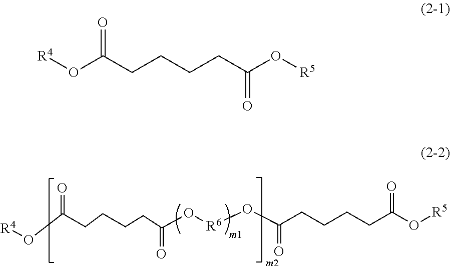

In the formulae (2-1) and (2-2), R⁴ and R⁵ each independently represents an alkyl group, or a polyoxyalkyl group [—(CₓH₂ₓ—O)_{y}—R^{A1}] (provided that R^{A1} represents an alkyl group, x represents an integer in the range of 1 to 10, and y represents an integer in the range of 1 to 10.).

R⁶ represents an alkylene group.

m1 represents an integer in the range of 1 to 20.

m2 represents an integer in the range of 1 to 10.

In the formulae (2-1) and (2-2), the alkyl groups represented by R⁴ and R⁵ are preferably alkyl groups having 1 to 6 carbon atoms, and more preferably alkyl groups having 1 to 4 carbon atoms. The alkyl groups represented by R⁴ and R⁵ may have any one of a linear shape, a branched shape, or a cyclic shape, but preferably a linear shape and a branched shape.

In the formulae (2-1) and (2-2), in the polyoxyalkyl group represented by R⁴ and R⁵ [—(CₓH₂ₓ—O)_{y}—R^{A1}], the alkyl group represented by R^{A1} is preferably an alkyl group having 1 to 6 carbon atoms, and more preferably an alkyl group having 1 to 4 carbon atoms. The alkyl group represented by R^{A1} may have any one of a linear shape, a branched shape, or a cyclic shape, but preferably a linear shape and a branched shape.

In the formula (2-2), the alkylene group represented by R⁶ is preferably an alkylene group having 1 to 6 carbon atoms, and more preferably an alkylene group having 1 to 4 carbon atoms. The alkylene group represented by R⁶ may have any one of a linear shape, a branched shape, or a cyclic shape, but preferably a linear shape and a branched shape.

In the formulae (2-1) and (2-2), the group represented by each of symbols R⁴ to R⁶ may be substituted with a substituent. As the substituent, an alkyl group, an aryl group, and a hydroxyl group are exemplified.

The molecular weight of the adipic acid ester (or weight average molecular weight) is preferably in the range of 200 to 5,000, and more preferably in the range of 300 to 2,000. The weight average molecular weight is a value measured according to the method of measuring the weight average molecular weight of the cellulose derivative described above.

Specific examples of the adipic acid ester-containing compound are described below, but the invention is not limited thereto.

| | Name of | Name of | |
|---|---|---|---|
| | Material | Product | Manufacturer |
| ADP1 | Adipic acid | Daifatty | Daihachi Chemical |
| | diester | 101 | Industry Co., Ltd. |
| ADP2 | Adipic acid | Adeka Cizer | ADEKA Corporation |
| | diester | RS-107 | |
| ADP3 | Adipic acid | Polycizer | DIC Corporation |
| | polyester | W-230-H | |

Polyether Ester Compound

As the polyether ester compound, or example, a polyether ester compound represented by the formula (2) is exemplified.

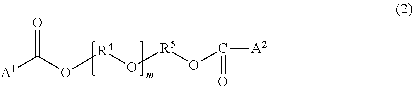

In the formula (2), R⁴ and R⁵ each independently represents an alkylene group having 2 to 10 carbon atoms. A¹ and A² each independently represents an alkyl group having 1 to 6 carbon atoms, an aryl group having 6 to 12 carbon atoms, or an aralkyl group having 7 to 18 carbon atoms. m represents an integer of 1 or greater.

In the formula (2), as the alkylene group represented by R⁴, an alkylene group having 3 to 10 carbon atoms is preferable, and an alkylene group having 3 to 6 carbon atoms is more preferable. The alkylene group represented by R⁴ may have any one of a linear shape, a branched shape, or a cyclic shape, but preferably a linear shape.

If the number of carbons of the alkylene group represented by R⁴ is set to be 3 or greater, the decrease of the fluidity of the resin composition is prevented, and thermoplasticity is easily exhibited. If the number of carbons of the alkylene group represented by R⁴ is 10 or lower, or the alkylene group represented by R⁴ has a linear shape, the affinity to the cellulose derivative is easily enhanced. Therefore, if the alkylene group represented by R⁴ has a linear shape, and the number of carbons is in the range described above, moldability of the resin composition is enhanced.

In this point of view, particularly, the alkylene group represented by R⁴ is preferably a n-hexylene group (—(CH₂)₆—). That is, the polyether ester compound is preferably a compound where R⁴ represents a n-hexylene group (—(CH₂)₆—).

In the formula (2), as the alkylene group represented by R⁵, an alkylene group having 3 to 10 carbon atoms is preferable, and an alkylene group having 3 to 6 carbon atoms is more preferable. The alkylene group represented by R⁵ may have any one of a linear shape, a branched shape, or a cyclic shape, but preferably a linear shape.

If the number of carbons of the alkylene group represented by R⁵ is 3 or greater, the decrease of the fluidity of the resin composition is prevented, and the thermoplasticity is easily exhibited. If the number of carbons of the alkylene group represented by R⁵ is 10 or lower, or if the alkylene group represented by R⁵ has a linear shape, the affinity to the cellulose derivative is easily enhanced. Therefore, if the alkylene group represented by R⁵ has a linear shape, and the number of carbons is in the range described above, moldability of the resin composition is enhanced.

In this point of view, particularly, the alkylene group represented by R⁵ is preferably a n-butylene group (—(CH₂)₄—). That is, the polyether ester compound is preferably a compound where R⁵ represents a n-butylene group (—(CH₂)₄—).

In the formula (2), the alkyl groups represented by A¹ and A² are alkyl groups having 1 to 6 carbon atoms, and alkyl groups having 2 to 4 carbon atoms are more preferable. The alkyl groups represented by A¹ and A² may have any one of a linear shape, a branched shape, or a cyclic shape, but preferably a branched shape.

The aryl groups represented by A¹ and A² are aryl groups having 6 to 12 carbon atoms, and as examples thereof, an unsubstituted aryl group such as a phenyl group and a naphthyl group or a substituted phenyl group such as a t-butylphenyl group and a hydroxyphenyl group are exemplified.

The aralkyl group represented by A¹ and A² is a group represented by —R^{A}-Ph. R^{A} represents a linear-shaped or branched alkylene group having 1 to 6 carbon atoms (preferably, having 2 to 4 carbon atoms). Ph represents an unsubstituted phenyl group or a substituted phenyl group which is substituted with the linear-shaped or branched alkyl group having 1 to 6 carbon atoms (preferably, having 2 to 6 carbon atoms). As the aralkyl group, specifically, for example, an unsubstituted aralkyl group such as a benzil group, a phenylmethyl group (phenethyl group), a phenylpropyl group, and a phenylbutyl group, and a substituted aralkyl group such as a methylbenzil group, a dimethylbenzil group, and a methylphenethyl group are exemplified.

At least one of A¹ and A² preferably represents an aryl group or an aralkyl group. That is, the polyether ester compound is preferably a compound where at least one of A¹ and A² represents an aryl group (preferably, phenyl group) or an aralkyl group, and preferably a compound where both of A¹ and A² represent an aryl group (preferably, phenyl group) or an aralkyl group.

Subsequently, characteristics of the polyether ester compound are described.

The weight average molecular weight (Mw) of the polyether ester compound is preferably in the range of 450 to 650, and more preferably in the range of 500 to 600.

If the weight average molecular weight (Mw) is 450 or greater, bleeding (phenomenon of deposition) becomes difficult. If the weight average molecular weight (Mw) is 650 or lower, the affinity to the cellulose derivative is easily enhanced. Therefore, if the weight average molecular weight (Mw) is in the range described above, moldability of the resin composition is enhanced.

In addition, the weight average molecular weight (Mw) of the polyether ester compound is a value measured by gel permeation chromatography (GPC). Specifically, the measurement of the molecular weight by GPC is performed by using HPLC1100 manufactured by Tosoh corporation as a measurement apparatus, and TSKgel GMHHR-M+TSKgel GMHHR-M (7.8 mm I.D. 30 cm) which is a column manufactured by Tosoh Corporation, with a chloroform solvent. Also, the weight average molecular weight is calculated by using a molecular weight calibration curve obtained by a monodispersed polystyrene standard sample from the measurement result.

The viscosity of the polyether ester compound at 25° C. is preferably in the range of 35 mPa·s to 50 mPa·s, and more preferably in the range of 40 mPa·s to 45 mPa·s.

If the viscosity is 35 mPa·s or greater, the dispersibility to the cellulose derivative is easily enhanced. If the viscosity is 50 mPa·s or lower, anisotropy of the dispersion of the polyether ester compound hardly appears. Therefore, if the viscosity is in the range described above, the moldability of the resin composition is enhanced.

In addition, the viscosity is a value measured by an E-type viscosmeter.

A solubility parameter (SP value) of the polyether ester compound is preferably in the range of 9.5 to 9.9, and more preferably in the range of 9.6 to 9.8.

If the solubility parameter (SP value) is in the range of 9.5 to 9.9, dispersibility to the cellulose derivative is easily enhanced.

The solubility parameter (SP value) is a value calculated by a Fedor method, and specifically, the solubility parameter (SP value) is, for example, calculated by the following equation in conformity with the description in Polym. Eng. Sci., vol. 14, p. 147 (1974).

SP value=√(Ev/v)=√(ΣΔei/ΣΔvi) Equation

(In the equation, Ev: evaporation energy (cal/mol), v: molar volume (cm³/mol), Δei: evaporation energy of each atom or atom group, and Δvi: molar volume of each atom or atom group)

In addition, the solubility parameter (SP value) employs (cal/cm³)^{1/2} as a unit, but the unit is omitted in conformity with practice, and is described in a dimensionless manner.

Hereinafter, specific examples of the polyether ester compound are described, but the invention is not limited thereto.

| | R⁴ | R⁵ | A¹ | A² | Mw | Viscosity (25° C.) | APHA | SP value |
|---|---|---|---|---|---|---|---|---|
| PEE1 | —(CH₂)₆— | —(CH₂)₄— | Phenyl group | Phenyl group | 550 | 43 | 120 | 9.7 |
| PEE2 | —(CH₂)₂— | —(CH₂)₄— | Phenyl group | Phenyl group | 570 | 44 | 115 | 9.4 |
| PEE3 | —(CH₂)₁₀— | —(CH₂)₄— | Phenyl group | Phenyl group | 520 | 48 | 110 | 10.0 |
| PEE4 | —(CH₂)₆— | —(CH₂)₂— | Phenyl group | Phenyl group | 550 | 43 | 115 | 9.3 |
| PEE5 | —(CH₂)₆— | —(CH₂)₁₀— | Phenyl group | Phenyl group | 540 | 45 | 115 | 10.1 |
| PEE6 | —(CH₂)₆— | —(CH₂)₄— | t-Butyl group | t-Butyl group | 520 | 44 | 130 | 9.7 |
| PEE7 | —(CH₂)₆— | —(CH₂)₄— | Phenyl group | Phenyl group | 460 | 45 | 125 | 9.7 |
| PEE8 | —(CH₂)₆— | —(CH₂)₄— | Phenyl group | Phenyl group | 630 | 40 | 120 | 9.7 |
| PEE9 | —(CH₂)₆— | —(CH₂)₄— | Phenyl group | Phenyl group | 420 | 43 | 135 | 9.7 |
| PEE10 | —(CH₂)₆— | —(CH₂)₄— | Phenyl group | Phenyl group | 670 | 48 | 105 | 9.7 |
| PEE11 | —(CH₂)₆— | —(CH₂)₄— | Phenyl group | Phenyl group | 550 | 35 | 130 | 9.7 |
| PEE12 | —(CH₂)₆— | —(CH₂)₄— | Phenyl group | Phenyl group | 550 | 49 | 125 | 9.7 |
| PEE13 | —(CH₂)₆— | —(CH₂)₄— | Phenyl group | Phenyl group | 550 | 32 | 120 | 9.7 |
| PEE14 | —(CH₂)₆— | —(CH₂)₄— | Phenyl group | Phenyl group | 550 | 53 | 105 | 9.7 |
| PEE15 | —(CH₂)₆— | —(CH₂)₄— | Phenyl group | Phenyl group | 550 | 43 | 135 | 9.7 |
| PEE16 | —(CH₂)₆— | —(CH₂)₄— | Phenyl group | Phenyl group | 550 | 43 | 105 | 9.7 |
| PEE17 | —(CH₂)₆— | —(CH₂)₄— | Phenyl group | Phenyl group | 550 | 43 | 150 | 9.7 |
| PEE18 | —(CH₂)₆— | —(CH₂)₄— | Phenyl group | Phenyl group | 550 | 43 | 95 | 9.7 |

Other Components

The resin composition according to the exemplary embodiment may contain other components in addition to the components described above, if necessary. As the other components, for example, a flame retardant, a compatibilizer, an antioxidant, a release agent, a light resistant agent, a weather resistant agent, a colorant, pigments, a modifier, a drip preventing agent, an antistatic agent, a hydrolysis inhibitor, a filler, and a reinforcing agent (glass fiber, carbon fiber, talc, clay, mica, glass flake, milled glass, glass bead, crystalline silica, alumina, silicon nitride, aluminum nitride, boron nitride, and the like) are exemplified. The content of the respective components is in the range of 0% by weight to 5% by weight with respect to the total amount of the resin composition. Here, the expression “0% by weight” means not including other components.

The resin composition according to the exemplary embodiment may contain other resins in addition to the resin described above. However, the other resins are included in amounts with which the ratio of the cellulose derivative occupied in the total amount of the resin composition becomes in the range described above.

As the other resins, for example, the thermoplastic resins which are well-known in the art are included. Specifically, polycarbonate resin; polypropylene resin; polyester resin; a polyolefin resin; polyester carbonate resin; a polyphenylene ether resin; polyphenylene sulfide resin; a polysulfone resin; polyether sulfone resin; a polyarylene resin; a polyetherimide resin; a polyacetal resin; a polyvinyl acetal resin; a polyketone resin; a polyetherketone resin; a polyetheretherketone resin; a polyarylketone resin; a polyether nitrile resin; a liquid crystal resin; a polybenzimidazole resin; polyparabanic acid resin; a vinyl-based polymer or a vinyl-based copolymer resin obtained by polymerizing or copolymerizing one or more vinyl monomers selected from the group consisting of an aromatic alkenyl compound, a methacrylic acid ester, acrylic acid ester, and a vinyl cyanide compound; a diene-aromatic alkenyl compound copolymer resin; a vinyl cyanide-diene-aromatic alkenyl compound copolymer resin; an aromatic alkenyl compound-diene-vinyl cyanide-N-phenylmaleimide copolymer resin; a vinyl cyanide-(ethylene-diene-propylene (EPDM))-aromatic alkenyl compound copolymer resin; a vinyl chloride resin; and a chlorinated vinyl chloride resin are exemplified. These resins may be used singly, or two or more types thereof may be used in combination.

Method of Preparing Resin Composition

The resin composition according to the exemplary embodiment is prepared, for example, by melting and kneading the mixture of the cellulose derivative and the components described above. In addition, the resin composition according to the exemplary embodiment is prepared by dissolving the components in a solvent. As a melting and kneading unit, well known units are included, and specifically, for example, a twin screw extruder, a Henschel mixer, a Banbury mixer, a single screw extruder, a multi-screw extruder, and a co-kneader are included.

In addition, the temperature at the time of kneading may be determined according to the melting temperature of the cellulose derivative used, but in view of the thermal decomposition and the fluidity, the temperature in the range of 140° C. to 240° C. is preferable, and the temperature in the range of 160° C. to 200° C. is more preferable.

Resin Molded Article

The resin molded article according to the exemplary embodiment includes the resin composition according to the exemplary embodiment. That is, the resin molded article according to the exemplary embodiment is made of the same composition as the resin composition according to the exemplary embodiment.

Specifically, the resin molded article according to the exemplary embodiment may be obtained by molding the resin composition according to the exemplary embodiment. As the molding method, injection molding, extrusion molding, blow molding, heat press molding, calendaring molding, coating molding, cast molding, dipping molding, vacuum molding, transfer molding and the like may be applied.

As the method of molding the resin molded article according to the exemplary embodiment, since degrees of freedom in shape are high, injection molding is preferable. With respect to injection molding, the resin composition is heated and melted, casted into a mold, and solidified, so as to obtain a molded article. The resin composition may be molded by injection compression molding.

The cylinder temperature of the injection molding is, for example, in the range of 140° C. to 240° C., preferably in the range of 150° C. to 220° C., and more preferably in the range of 160° C. to 200° C. The mold temperature of the injection molding is, for example, in the range of 30° C. to 120° C., and more preferably in the range of 40° C. to 80° C. The injection molding may be performed, for example, by using a commercially available apparatus such as NEX500 manufactured by Nissei Plastic Industrial Co., Ltd., NEX150 manufactured by Nissei Plastic Industrial Co., Ltd., NEX70000 manufactured by Nissei Plastic Industrial Co., Ltd., and SE50D manufactured by Toshiba Machine Co., Ltd.

The resin molded article according to the exemplary embodiment may be appropriately used for the purposes of electric and electronic apparatuses, business machines, home appliances, automobile interior materials, engine covers, car bodies, containers, and the like. More specifically, the resin molded article may be used in housings of electric and electronic apparatuses or home appliances; various components of electric and electronic apparatuses or home appliances; interior components of automobiles; storage cases of CD-ROM, DVD, and the like; food containers; drink bottles; food trays; wrapping materials; films; and sheets.

### Examples

Hereinafter, the invention is described in greater detail with reference to examples, but the invention is not limited to the examples. In addition, unless described otherwise, the expression “part” refers to “part by weight”.

Preparation of Cellulose

2 kg of cellulose (KC Flock W50 manufactured by Nippon Paper Industries Co., Ltd.) is put to 20 L of an aqueous solution of 0.1 M hydrochloric acid, and stirred at room temperature (25° C.). In stirring time shown in Table 1, cellulose in respective molecular weights is obtained. In addition, EP-1800 (product name, manufactured by Shinto Scientific Co., Ltd.) is used as a stirring apparatus, and the rotation speed at the time of stirring is set to 500 rpm.

The weight average molecular weight is measured with a GPC apparatus (manufactured by Tosoh corporation, HLC-8320GPC, Column: TSKgel α-M), by using a solution of dimethylacetamide/lithium chloride having a volume ratio of 90/10.

TABLE 1

| | | Weight |
|---|---|---|
| | Stirring | average |
| | time | molecular |
| | (hr) | weight |
| Compound 1 | 0.3 | 75,500 |
| Compound 2 | 1 | 57,800 |
| Compound 3 | 2 | 31,000 |
| Compound 4 | 3 | 10,300 |
| Compound 5 | 5 | 9,400 |

Preparation of Cellulose Derivative

Acetylation Step

Pretreatment activation is performed by spraying 1 kg of Compound 1 in Table 1, with 500 g of glacial acetic acid. Thereafter, a mixture of 3.8 kg of glacial acetic acid, 2.4 kg of acetic anhydride, and 80 g of sulfuric acid is added, and esterification of Compound 1 is performed while the mixture is stirred and mixed at a temperature of 40° C. or lower. Esterification is finished when fiber fragments disappear.

Deacetylation Step

2 kg of acetic acid and 1 kg of water are added to the mixture, and stirred for 2 hours at room temperature (25° C.)

Refinement Step

Further, this solution is slowly dripped to a solution obtained by dissolving 20 kg of sodium hydroxide in 40 kg of water while the solution is stirred. The obtained white precipitate is suction-filtered and washed with 60 kg of water, and a cellulose derivative (Compound 6) is obtained.

Cellulose derivatives (Compounds 7 to 10) are obtained in the same manner as described above except for changing Compound 1 to Compounds 2 to 5.

A cellulose derivative (Compound 11) is obtained in the same manner as described above except for using Compound 3 performing a refinement step right after an acetylation step is finished.

Cellulose derivatives (Compounds 12 to 16) are obtained in the same manner as described above except for using Compound 3 changing stirring time in deacetylation steps to 0.5 hours, 1 hour, 3 hours, 5 hours, and 10 hours, respectively.

Cellulose derivatives (Compounds 17 to 19) are obtained in the same manner as described above except for using Compound 3 and changing 2.4 kg of acetic anhydride in an acetylation step respectively to 2 kg of propionic anhydride/0.3 kg of acetic anhydride and 1.8 kg of n-butyric anhydride/6 kg of acetic anhydride and 0.5 kg of n-hexanoic anhydride.

Weight average molecular weights are obtained in the same manner as in Compound 1, and substitution degrees are obtained with H¹-NMR measurement (JNM-ECZR manufactured by JEOL Ltd.).

The results are collectively shown in Table 2.

TABLE 2

| | Weight | | |
|---|---|---|---|
| | average | | Substi- |
| | molecular | | tution |
| | weight | Substituent | degree |
| Compound 6 | 79,800 | Acetyl | 2.15 |
| Compound 7 | 63,300 | Acetyl | 2.22 |
| Compound 8 | 38,800 | Acetyl | 2.25 |
| Compound 9 | 11,000 | Acetyl | 2.21 |
| Compound 10 | 9,900 | Acetyl | 2.19 |
| Compound 11 | 42,300 | Acetyl | 2.78 |
| Compound 12 | 40,500 | Acetyl | 2.59 |
| Compound 13 | 39,000 | Acetyl | 2.48 |
| Compound 14 | 37,000 | Acetyl | 1.65 |
| Compound 15 | 36,100 | Acetyl | 0.38 |
| Compound 16 | 35,800 | Acetyl | 0.25 |
| Compound 17 | 42,500 | n-propionyl/acetyl | 2.05/0.35 |
| Compound 18 | 44,300 | n-butanoyl/acetyl | 1.88/0.55 |
| Compound 19 | 36,000 | n-hexanoyl | 0.55 |

Cellulose Derivatives C-1 to C-6 obtained in Synthesis Examples 1 to 6 (paragraphs [0107] to [0112]) of Japanese Patent No. 5,470,032 are set to Compounds 20 to 25, respectively.

TABLE 3

| | Synthesis | | | |
|---|---|---|---|---|
| | example of | Weight | | |
| | Japanese | average | | Substi- |
| | Patent No. | molecular | | tution |
| | 5,470,032 | weight | Substituent | degree* |
| Compound 20 | C-1 | 185,000 | Methyl/propylene | 1.95/1.05 |
| | | | oxy acetyl + | |
| | | | acetyl | |
| Compound 21 | C-2 | 617,000 | Methyl/propylene | 1.84/1.16 |
| | | | oxy acetyl + | |
| | | | acetyl | |
| Compound 22 | C-3 | 770,000 | Methyl/propylene | 1.47/1.53 |
| | | | oxy acetyl + | |
| | | | acetyl | |
| Compound 23 | C-4 | 680,000 | Methyl/propylene | 1.45/1.55 |
| | | | oxy acetyl + | |
| | | | acetyl | |
| Compound 24 | C-5 | 402,000 | Methyl/propylene | 1.5/1.5 |
| | | | oxy propionyl + | |
| | | | propionyl | |
| Compound 25 | C-6 | 237,000 | Methyl/propylene | 1.43/1.57 |
| | | | oxy acetyl + | |
| | | | acetyl | |

*Substitution degree of alkyl/Sum of substitution degree of alkyleneoxyacyl and substitution degree of acyl

Preparation of Pellets

According to the composition ratio and the kneading temperature with respect to each of Examples 1 to 15 and Comparative Examples 1 to 10 as shown in Table 4, the cellulose derivative and the plasticizer are kneaded with a twin screw kneading apparatus (TEX41SS manufactured by Toshiba Machine Co., Ltd.) to thereby obtain the respective resin composition pellets.

TABLE 4

| | | | Kneading |
|---|---|---|---|
| | Composition ratio | | temper- |
| | Cellulose derivative | Plasticizer | ature |
| | (parts) | (parts) | (° C.) |
| Example 1 | Compound 7 (97) | Compound 26 (3) | 200 |
| Example 2 | Compound 8 (97) | Compound 26 (3) | 190 |
| Example 3 | Compound 9 (97) | Compound 26 (3) | 180 |
| Example 4 | Compound 11 (97) | Compound 26 (3) | 180 |
| Example 5 | Compound 12 (97) | Compound 26 (3) | 190 |
| Example 6 | Compound 13 (97) | Compound 26 (3) | 190 |
| Example 7 | Compound 14 (97) | Compound 26 (3) | 190 |
| Example 8 | Compound 15 (97) | Compound 26 (3) | 200 |
| Example 9 | Compound 16 (97) | Compound 26 (3) | 200 |
| Example 10 | Compound 17 (97) | Compound 26 (3) | 160 |
| Example 11 | Compound 18 (97) | Compound 26 (3) | 160 |
| Example 12 | Compound 19 (97) | Compound 26 (3) | 170 |
| Example 13 | Compound 8 (95) | Compound 26 (5) | 180 |
| Example 14 | Compound 8 (90) | Compound 26 (10) | 160 |
| Example 15 | Compound 8 (85) | Compound 26 (15) | 150 |
| Comparative | Compound 6 (97) | Compound 26 (3) | 200 |
| Example 1 | | | |
| Comparative | Compound 10 (97) | Compound 26 (3) | 170 |
| Example 2 | | | |
| Comparative | Compound 6 (90) | Compound 26 (10) | 180 |
| Example 3 | | | |
| Comparative | Compound 10 (90) | Compound 26 (10) | 160 |
| Example 4 | | | |
| Comparative | Compound 20 (97) | Compound 26 (3) | 200 |
| Example 5 | | | |
| Comparative | Compound 21 (97) | Compound 26 (3) | 205 |
| Example 6 | | | |
| Comparative | Compound 22 (97) | Compound 26 (3) | 200 |
| Example 7 | | | |
| Comparative | Compound 23 (97) | Compound 26 (3) | 200 |
| Example 8 | | | |
| Comparative | Compound 24 (97) | Compound 26 (3) | 190 |
| Example 9 | | | |
| Comparative | Compound 25 (97) | Compound 26 (3) | 190 |
| Example 10 | | | |

In addition, details of Compound 26 shown in Table 4 are described below.
Compound 26: adipic acid ester mixture (Daifatty 101 manufactured by Daihachi Chemical Industry Co., Ltd.)

Melt Viscosity

With respect to obtained pellets (resin composition), melt viscosity (Pa·s) is measured in conformity with JIS K7199 (1999) by using Capilograph-1C (Toyo Seiki Seisaku-sho, Ltd.), in the condition in which the shear velocity is 1,000/s and the temperature is 220° C.

The results are shown in Table 5.

Injection Molding

With the obtained pellets, ISO multi-purpose dumbbell test samples (test portion: 100 mm in length, 10 mm in width, and 4 mm in thickness) are manufactured at cylinder temperatures and mold temperatures shown in Table 5 using an injection molding machine (PNX40 manufactured by Nissei Plastic Industrial Co., Ltd.).

Odor of Molded Article

With respect to the obtained test samples, whether odor resulting from the degradation of the cellulose derivatives is generated is determined by checking direct odor. The results are shown in Table 5.

Generation of Melt Fracture

With respect to purge resins obtained in the injection molding, whether cellulose derivatives (melt fractures) which are not fully melted and remain in a solid lump state exist is visually checked. The results are shown in Table 5.

Bending Elastic Modulus

With respect to the obtained dumbbell test samples, bending elastic moduli are measured with a method in conformity with ISO-178 by using a universal testing device (Autograph AG-Xplus manufactured by Shimadzu Corporation). The results are shown in Table 5.

TABLE 5

| | Melt viscosity (Pa · s) | Molding condition | | Odor of | | Bending elastic |
|---|---|---|---|---|---|---|
| | Pellet | Cylinder temperature | Mold temperature | molded | | modulus |
| | (resin composition) | (° C.) | (° C.) | article | Melt fracture | (MPa) |
| Example 1 | 185 | 200 | 40 | No Odor | No fracture | 4400 |
| Example 2 | 134 | 190 | 40 | No Odor | No fracture | 4300 |
| Example 3 | 101 | 180 | 40 | No Odor | No fracture | 4400 |
| Example 4 | 142 | 180 | 40 | No Odor | No fracture | 4800 |
| Example 5 | 140 | 190 | 40 | No Odor | No fracture | 4600 |
| Example 6 | 143 | 190 | 40 | No Odor | No fracture | 4400 |
| Example 7 | 135 | 190 | 40 | No Odor | No fracture | 4500 |
| Example 8 | 130 | 200 | 40 | No Odor | No fracture | 4550 |
| Example 9 | 120 | 200 | 40 | No Odor | No fracture | 4800 |
| Example 10 | 161 | 160 | 40 | No Odor | No fracture | 4000 |
| Example 11 | 165 | 160 | 40 | No Odor | No fracture | 3800 |
| Example 12 | 133 | 170 | 40 | No Odor | No fracture | 3800 |
| Example 13 | 128 | 180 | 40 | No Odor | No fracture | 4100 |
| Example 14 | 120 | 160 | 40 | No Odor | No fracture | 4050 |
| Example 15 | 114 | 150 | 40 | No Odor | No fracture | 3750 |
| Comparative Example 1 | 220 | 240 | 40 | Odor | No fracture | 3000 |
| Comparative Example 2 | 80 | 170 | 40 | No Odor | No fracture | 1750 |
| Comparative Example 3 | 203 | 240 | 40 | Odor | No fracture | 2850 |
| Comparative Example 4 | 65 | 160 | 40 | No Odor | No fracture | 1350 |
| Comparative Example 5 | 382 | 240 | 40 | Odor | Fracture | 1550 |
| Comparative Example 6 | 760 | 250 | 40 | Odor | Fracture | 1450 |
| Comparative Example 7 | 1023 | 260 | 40 | Odor | Fracture | 1400 |
| Comparative Example 8 | 852 | 260 | 40 | Odor | Fracture | 1300 |
| Comparative Example 9 | 560 | 240 | 40 | Odor | Fracture | 1550 |
| Comparative Example 10 | 459 | 240 | 40 | Odor | Fracture | 1550 |

In the resin compositions and the resin molded articles of the examples described above in which melt viscosity of the resin compositions containing 80% by weight or more of cellulose derivatives is in the range described above, thermal decomposition of the cellulose derivatives is prevented, and moldability is excellent, compared with the comparative examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition comprising 80% by weight or more of a cellulose derivative with respect to a total amount of a resin composition and
having a melt viscosity in a range of from 100 Pa·s to 200 Pa·s at a temperature of 220° C. and a shear velocity of 1,000/s.

2. The resin composition according to claim 1,
wherein a weight average molecular weight of the cellulose derivative is 10,000 or greater and less than 75,000.

3. The resin composition according to claim 1,
wherein the cellulose derivative is a cellulose derivative in which at least one hydroxyl group of cellulose is substituted with an acyl group having 1 to 6 carbon atoms.

4. The resin composition according to claim 2,
wherein the cellulose derivative is a cellulose derivative in which at least one hydroxyl group of cellulose is substituted with an acyl group having 1 to 6 carbon atoms.

5. The resin composition according to claim 3,
wherein a substitution degree of the acyl group having 1 to 6 carbon atoms in the cellulose derivative is in a range of from 1.8 to 2.5.

6. The resin composition according to claim 4,
wherein a substitution degree of the acyl group having 1 to 6 carbon atoms in the cellulose derivative is in a range of from 1.8 to 2.5.

7. The resin composition according to claim 1, further comprising:
a plasticizer.

8. The resin composition according to claim 7,
wherein the plasticizer is at least one selected from the group consisting of an adipic acid ester-containing compound and a polyether ester compound.

9. A resin molded article comprising the resin composition according to claim 1.

10. The resin molded article according to claim 9, which is molded by injection molding.
